(19) United States
(12) Patent Application Publication
(10) Pub. No.: US 2025/0386833 A1
(43) Pub. Date: Dec. 25, 2025

(54) DEVICE TO SUBMERGE FOODS IN LIQUID

(71) Applicant: Michael James Osegaro, Newell, IA (US)

(72) Inventor: Michael James Osegaro, Newell, IA (US)

(21) Appl. No.: 19/020,233

(22) Filed: Jan. 14, 2025

Related U.S. Application Data
(60) Provisional application No. 63/663,349, filed on Jun. 24, 2024.

(51) Int. Cl. A23B 2/792; A23L 19/20

(52) U.S. Cl. CPC A23B 2/792; A23L 19/20

(57) ABSTRACT

A device for holding down and/or containing produce or other food for fermentation, pickling, marinating, brining and/or otherwise submerging food in a liquid is disclosed. This product will solve multiple issues including the containment of small pieces of produce/food by keeping the produce/food submerged and thus helping to stop mold growth. It will also solve the issue of a product fitting the body of the container tightly. This product will not fall to the bottom, is food safe, and holds down and contains small pieces of produce/food for fermentation, pickling, marinating, brining and/or otherwise submerging food in a liquid.

### CROSS-REFERENCE TO RELATED APPLICATION

This application claims the benefit of priority of U.S. provisional application No. 63/663,349, filed Jun. 24, 2024, the contents of which are herein incorporated by reference.

### BACKGROUND OF THE INVENTION

During fermentation, fruits and vegetables are submerged under a liquid solution for a particular amount of time. This process produces carbon dioxide which forces the fruits and vegetables to float to the top. Often, the fruits and vegetables are in small pieces. These issues lead to difficulty in containing and holding down the fruits and vegetables under the liquid due to the carbon dioxide produced and the buoyancy from the salt.

Another problem with fermentation is mold growth due to produce being above the water line and not held below the water. Keeping other foods, outside of produce, under liquid for pickling, marinating, and brining also have these same issues.

There are products that attempt to solve these and other problems with fermenting foods, but they do not do so effectively. Many such materials are too rigid like rocks, stones, weights, or plates, and such devices also cannot expand to fit the sides of the container and hold all the pieces of produce/food down. Most conventional devices are designed for much smaller vessels like pint or quart jars.

Some people use plastic bags for fermenting, but these present problems of their own. Plastic bags often rupture while the fermentation, pickling, marinating, brining, and/or otherwise submerging food in a liquid process is taking place.

No current products fully address the issue of small pieces of produce/food floating in the liquid solution. Also, no existing solution addresses the issue of trapped gases.

The present invention is directed at solving these and other issues, including the containment of small pieces of produce/food by keeping the produce/food submerged and thus helping to stop mold growth. It will also solve the issue of a product fitting the body of the container tightly. This product will not fall to the bottom, is food safe, and holds down and contains small pieces of produce/food for fermentation, pickling, marinating, brining and/or otherwise submerging food in a liquid.

### SUMMARY OF THE INVENTION

In one aspect of the present invention, there is disclosed a device for holding down and/or containing produce or other food for fermentation, pickling, marinating, brining and/or otherwise submerging food in a liquid. This product will solve multiple issues including the containment of small pieces of produce/food by keeping the produce/food submerged and thus helping to stop mold growth. It will also solve the issue of a product fitting the body of the container tightly. This product will not fall to the bottom, is food safe, and holds down and contains small pieces of produce/food for fermentation, pickling, marinating, brining and/or otherwise submerging food in a liquid.

These and other features, aspects, and advantages of the present invention will become better understood with reference to the following drawings, description and claims.

### BRIEF DESCRIPTION OF THE DRAWINGS

FIG. 1 is a perspective view of a device to submerge foods in liquid, shown in use, in accordance with a preferred embodiment of the present invention;

FIG. 2 is a perspective view of a device to submerge foods in liquid constructed in accordance with a preferred embodiment of the present invention;

FIG. 3 is a front view of a device to submerge foods in liquid constructed in accordance with a preferred embodiment of the present invention;

FIG. 4 is a section view of the present invention taken along line 4-4 in FIG. 2;

FIG. 5 is a front view of a device to submerge foods in liquid, shown in use, in accordance with a preferred embodiment of the present invention; and

FIG. 6 is a front view of a device to submerge foods in liquid, shown in use, in accordance with a preferred embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

As stated above, during fermentation, fruits and vegetables are submerged under a liquid solution for a particular amount of time. This process produces carbon dioxide which forces the fruits and vegetables to float to the top. Often, the fruits and vegetables are in small pieces. These issues lead to difficulty in containing and holding down the fruits and vegetables under the liquid. Another one of the biggest problems with fermentation is mold growth due to produce being above the water line and not held below the water. Keeping other foods, outside of produce, under liquid for pickling, marinating, and brining also have these same issues. The invention claimed here solves this problem.

The shape and design of the present invention will fit snugly down into a fermentation jar, or other container to keep fruits, vegetables, and other foods submerged, and small pieces contained so they do not float on the top of the water. The holes in the design will allow for CO2 gases to escape freely without getting trapped.

The present invention differs from what currently exists. Prior to this invention, most people used either plastic bags, rocks, stones, weights, dishware, or other non-specific solutions to hold down produce/food under the water line. This product will solve multiple issues including the containment of small pieces of produce/food and keeping the produce/food submerged. Unlike many of these non-specific solutions, this product is designed for this purpose and is made from a food-safe material. With other non-specific solutions like the ones listed above, there is potential for contamination due to those products being used for other purposes.

Conventional devices do not work well because they are not designed to fit a particular vessel. Nearly all fermentation jars/standard jars have a smaller neck than the body of the jar. That means that rigid products like weights or plates will never fit the body of the jar because they cannot fit into the neck of the jar.

Rigid but small objects like rocks or stones need to be clean and food safe and often put into a bag or other vessel so they don't fall to the bottom. The bag or vessel must be food safe also. Nothing is designed to fit the size of the container, and they do not solve the issue of small pieces of floating produce/food that can cause mold to form. Some of these products can also have an issue with trapped gases due to fermentation.

The product of the present invention will solve multiple issues including the containment of small pieces of produce/food by keeping the produce/food submerged and thus helping to stop mold growth. It will also solve the issue of a product fitting the body of the container tightly. This product will not fall to the bottom, is food safe, and holds down and contains small pieces of produce/food for fermentation, pickling, marinating, brining and/or otherwise submerging food in a liquid.

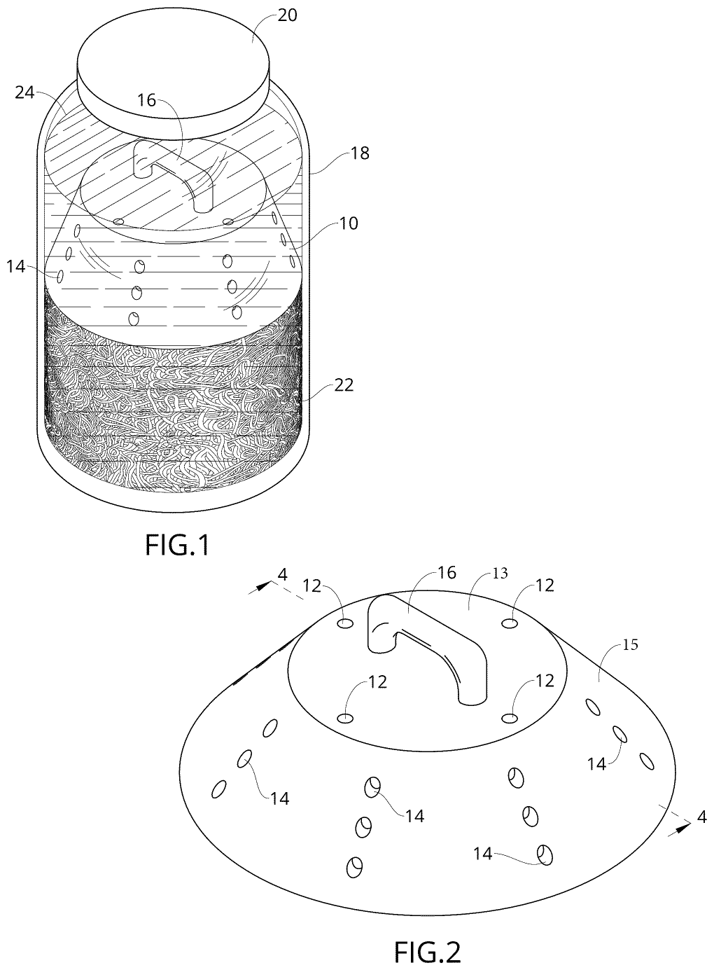

As discussed herein, and as seen in FIGS. 1-6 hereto, in a preferred embodiment the device of the present invention comprises a single, flexible, non-reactive, food-safe, generally cone-shaped silicone container that is molded to a desired form. The product has numerous holes that allow gases to escape during fermentation, while also allowing water to flow through when using the product as a strainer, and the design also allows steam to go through when using product as a cover for heating foods that may splatter. The product can also include a handle for grasping and moving the product as needed.

FIG. 1 depicts device 10 of the present invention positioned within a fermenting jar 18, or other jar. As seen in FIG. 1, jar 18 can be closed with a lid 20 with device 10 inside of the jar. Device 10 keeps the food material 22 below device 10, while holes 14 in device 10 allow liquid 24 (and gases) to pass through device 10 to the upper portion of jar 18 above device 10.

FIG. 2 depicts a food fermenting/containing device constructed in accordance with a preferred embodiment of the present invention. The device comprises a handle 16 at the top end connected to a substantially flat portion 13 that includes numerous holes 12 therethrough. Flat portion 13 is connected to substantially conically shaped lower portion 15, which also includes numerous holes 14 therethrough.

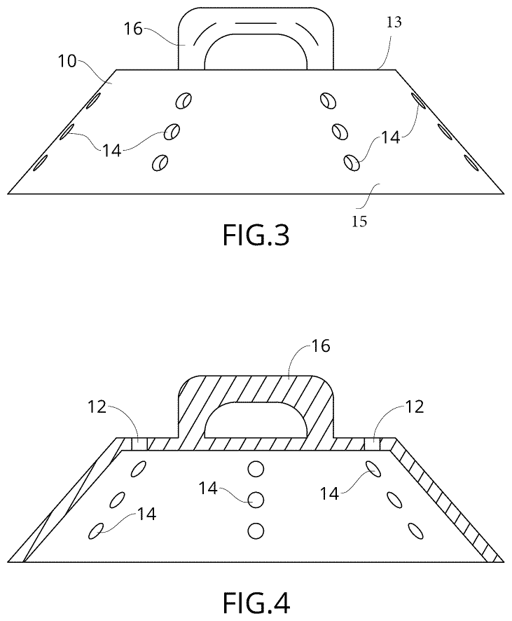

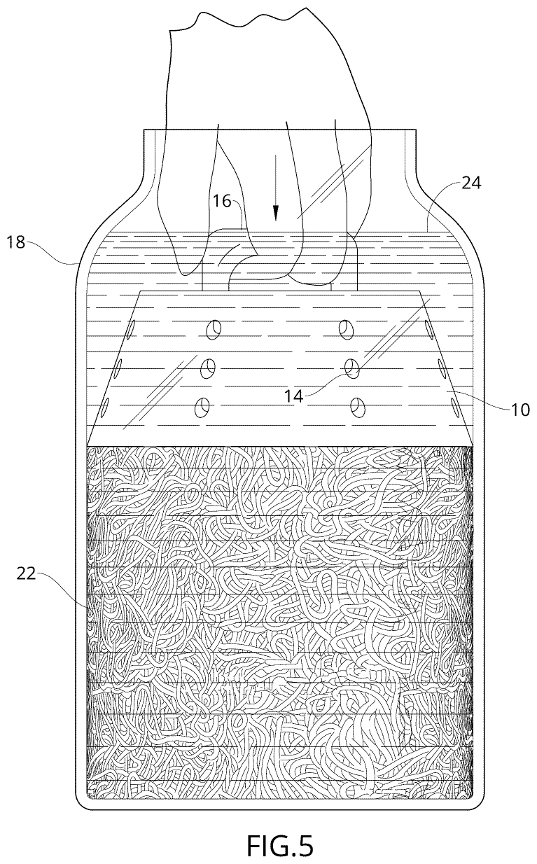

FIGS. 3 and 4, show additional views of device 10 of the present invention with handle 16, flat portion 13 with holes 12 therethrough, and substantially conical lower section 15 also having holes 14 therethrough.

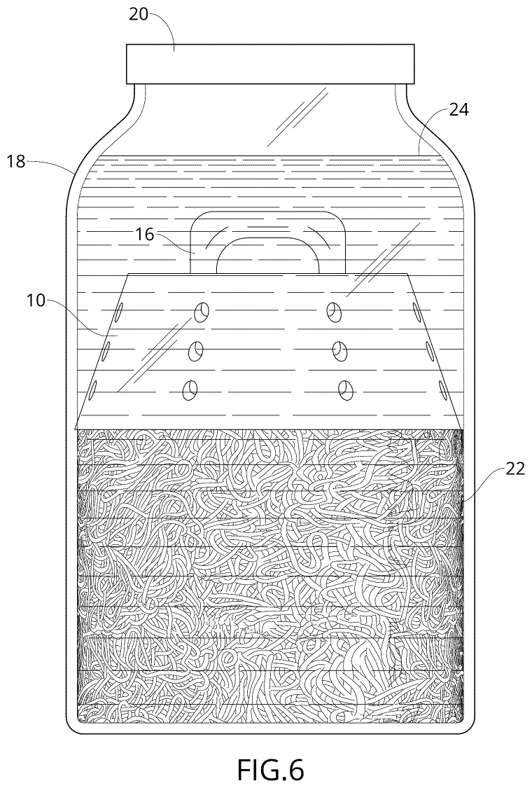

FIGS. 5 and 6 show device 10 in use. As seen in FIG. 5, device 10 is flexible such that it can be inserted inside jar 18 while maintaining contact with the inner walls of jar 10. Holes 12 and 14 allow the liquid 24 (and air) within jar 24 to pass from below device 10 to the area above device 10 within jar 18, while maintaining food 22 to below device 10 within jar 18 while device 10 is pressed downward within jar 18. Once the desired depth of device 10 is achieved with jar 18, lid 20 can be affixed to the top of the jar.

The shape and design of the product will allow it to be inserted into various sizes of vessels and hold down submerged fruits, vegetables, and other food for fermentation, pickling, marinating, brining and/or otherwise submerging food in a liquid. The shape will also help contain small pieces of produce/food below the water/fermentation solution. The holes 12/14 in the product will allow gases to escape out of the container. The holes will also allow water to flow through the product when using as a strainer and steam to escape and reduce splatter when using product as a food cover when heating foods in the microwave, on the stove, or other heating sources. The non-reactive, food-safe material it is made from will prevent harmful substances from leaching into the food. Its flexible nature will eliminate the possibility of sharp pieces breaking off into the food. The handle on the top will allow for easy grasping of the product and manipulation when placing it inside or removing out of larger vessels.

A person who would want to submerge produce or other food under a liquid for fermentation, pickling, marinating, brining and/or otherwise submerging food in a liquid, would insert product 10 into a container 18 on top of the food 22. Additional liquid 24 could be added prior or after inserting the product into the container. The person would wait for an amount of time which would vary for each particular use case. After this time, the product doubles as a strainer allowing the person to remove the liquid separately from the produce/food if needed. If it is not necessary or desired to separate the liquid from the solids, the person may remove the product from the container by pulling up on the handle on the top of the product. The product will need to be folded or otherwise bend/collapsed to fully remove the product from the container. The product can then be washed and reused as needed.

Other applications of the invention are being used as a strainer, both inside of a vessel or outside of a vessel by inverting and pouring liquid through. Also to use the invention as a cover for heating foods in a microwave, on stove, or other heating sources such as on a pot as a lid or on a bowl or other vessel to prevent splattering or splashing. Also, the invention can be used as a jar gripper due to the flexible silicone being used as the material.

It should be understood, of course, that the foregoing relates to exemplary embodiments of the invention and that modifications may be made without departing from the spirit and scope of the invention as set forth in the following claims.

What is claimed is:

1. A food fermenting/containing device comprising:
a handle at the top end of the device that is connected to a substantially flat circular portion that includes numerous holes therethrough, wherein the flat portion is connected to a substantially conically shaped lower portion which includes numerous holes therethrough.

2. The device of claim 1, wherein the flat portion and the conical portion are each made of flexible, non-reactive, food-safe, silicone.

3. The device of claim 1, wherein the device is constructed to be positioned within a fermenting jar having a food product and a liquid therein, and wherein the device keeps the food material below the device and the holes allow the liquid to pass through device to the upper portion of the jar.

4. The device of claim 1, wherein there are at least four holes in the flat portion of the device.

5. The device of claim 1, wherein there are at least twenty holes in the conical portion of the device.
